(19) United States
(12) Patent Application Publication
(10) Pub. No.: US 2026/0089410 A1
(43) Pub. Date: Mar. 26, 2026

(54) IMAGE SENSING DEVICE AND METHOD FOR OPERATING THE SAME

(71) Applicant: SK hynix Inc., Gyeonggi-do (KR)

(72) Inventors: Ji Hee HAN, Gyeonggi-do (KR); Ju Hyun CHO, Gyeonggi-do (KR)

(21) Appl. No.: 19/334,970

(22) Filed: Sep. 22, 2025

(30) Foreign Application Priority Data
Sep. 24, 2024 (KR) 10-2024-0129083

(51) Int. Cl. H04N 25/773; H04N 25/709

(52) U.S. Cl. CPC H04N 25/773; H04N 25/709

(57) ABSTRACT

An image sensing device includes: a plurality of single-photon avalanche diodes (SPADs); a voltage acquisition circuit configured to acquire a) a first candidate voltage including a first anode voltage and a first cathode voltage for the plurality of SPADs and b) a second candidate voltage including a second anode voltage and a second cathode voltage for the plurality of SPADs; a voltage determiner configured to determine one of the first candidate voltage and the second candidate voltage as a final voltage based on at least one of a reliability margin of the plurality of SPADs or a stability margin of the plurality of SPADs; and a voltage applying circuit configured to apply the final voltage to each of the plurality of SPADs.

### CROSS-REFERENCE TO RELATED APPLICATIONS

This patent document claims the priority and benefits of Korean patent application No. 10-2024-0129083, filed on Sep. 24, 2024, the disclosure of which is incorporated herein by reference in its entirety as part of the disclosure of this patent document.

### TECHNICAL FIELD

Embodiments of the present disclosure relate to an image sensing device and a method for operating the same.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smartphones, digital cameras, game machines, IoT (Internet of Things), robots, security cameras and medical micro cameras.

Recently, image sensing devices have been actively used not only to acquire color images but also to sense the distance to a target object to be captured. In particular, a direct time of flight (D-ToF) method, which directly or indirectly measures a time duration in which light is reflected from the target object and returns to the image sensing device, has been widely used.

### SUMMARY

Various embodiments of the present disclosure relate to an image sensing device that determines an optimal single-photon avalanche diode (SPAD) voltage by considering both a reliability margin and a stability margin.

Various embodiments of the present disclosure relate to an image sensing device having a stable standby current.

Various embodiments of the present disclosure relate to an image sensing device that determines an optimal SPAD voltage based on an excess voltage.

In accordance with an embodiment of the present disclosure, an image sensing device may include: a plurality of single-photon avalanche diodes (SPADs); a voltage acquisition circuit configured to acquire a first candidate voltage and a second candidate voltage, the first candidate voltage including a first anode voltage and a first cathode voltage for the plurality of SPADs, and the second candidate voltage including a second anode voltage and a second cathode voltage for the plurality of SPADs; a voltage determiner configured to determine one of the first candidate voltage and the second candidate voltage as a final voltage based on at least one of a reliability margin of the plurality of SPADs or a stability margin of the plurality of SPADs; and a voltage applying circuit configured to apply the final voltage to each of the plurality of SPADs.

In some implementations, the voltage determiner may determine, as the final voltage, a candidate voltage including an anode voltage having a greater reliability margin among the first anode voltage and the second anode voltage.

In some implementations, the voltage determiner may determine, as the final voltage, a candidate voltage including an anode voltage having a smaller magnitude among the first anode voltage and the second anode voltage.

In some implementations, the voltage determiner may determine, as the final voltage, a candidate voltage having a lower excess voltage among the first candidate voltage and the second candidate voltage when the first anode voltage and the second anode voltage are equal to each other.

In some implementations, the voltage determiner may determine, based on the stability margin of the plurality of SPADs, as the final voltage, a candidate voltage corresponding to a smaller difference value between a first difference value and a second difference value when the first anode voltage and the second anode voltage are equal to each other. The first difference value is a difference between the first anode voltage and the first cathode voltage; and the second difference value is a difference between the second anode voltage and the second cathode voltage.

In some implementations, the voltage determiner may determine, as the final voltage, a candidate voltage corresponding to a higher value among a first value and a second value. The first value may be obtained by subtracting half of a magnitude of the first cathode voltage from a magnitude of a first excess voltage of the first candidate voltage; and the second value may be obtained by subtracting half of a magnitude of the second cathode voltage from a magnitude of a second excess voltage of the second candidate voltage.

In some implementations, the voltage determiner may determine, as the final voltage, a candidate voltage having a stability margin greater than or equal to a threshold margin among the first candidate voltage and the second candidate voltage.

In some implementations, the voltage determiner may determine, as the final voltage, a candidate voltage including a voltage having a smaller magnitude among the first anode voltage and the second anode voltage when each of a first stability margin by the first candidate voltage and a second stability margin by the second candidate voltage is greater than or equal to a threshold margin.

In some implementations, the voltage determiner may determine, as the final voltage, a candidate voltage that causes the plurality of SPADs to have a standby current lower than a threshold current, among the first candidate voltage and the second candidate voltage.

In some implementations, the voltage determiner may determine, as the final voltage, a candidate voltage including an anode voltage having a smaller magnitude among the first anode voltage and the second anode voltage when each of a first standby current by the first candidate voltage and a second standby current by the second candidate voltage is less than a threshold current.

In some implementations, the plurality of SPADs may include a first SPAD and a second SPAD. The voltage acquisition circuit may acquire the first candidate voltage by measuring voltages applied to the first SPAD; and may acquire the second candidate voltage by measuring voltages applied to the second SPAD.

In accordance with another embodiment of the present disclosure, an image sensing device may include: a plurality of single-photon avalanche diodes (SPADs); a voltage acquisition circuit configured to acquire a first candidate voltage including a) a first ON voltage applied to each of the plurality of SPADs when the plurality of SPADs is in an ON state in which the plurality of SPADs operates in a Geiger mode and b) a first OFF voltage applied to each of the plurality of SPADs when the plurality of SPADs is in an OFF state in which one terminal of each of the plurality of SPADs is grounded, and acquire a second candidate voltage including a second ON voltage and a second OFF voltage; a voltage determiner configured to determine one of the first candidate voltage and the second candidate voltage as a final voltage based on at least one of a reliability margin of the plurality of SPADs or a stability margin of the plurality of SPADs; and a voltage applying circuit configured to apply the final voltage to each of the plurality of SPADs.

In some implementations, the voltage determiner may determine, as the final voltage, a candidate voltage including an OFF voltage having a greater reliability margin among the first OFF voltage and the second OFF voltage.

In some implementations, the voltage determiner may determine, as the final voltage, a candidate voltage including an OFF voltage having a smaller magnitude among the first OFF voltage and the second OFF voltage.

In some implementations, the voltage determiner may determine, as the final voltage, a candidate voltage including an excess voltage having a smaller magnitude among the first candidate voltage and the second candidate voltage when the first OFF voltage and the second OFF voltage are equal to each other.

In some implementations, the voltage determiner may determine, as the final voltage, a candidate voltage having a lower ON voltage among the first ON voltage and the second ON voltage when the first OFF voltage and the second OFF voltage are equal to each other.

In some implementations, the voltage determiner may determine, as the final voltage, a candidate voltage having a stability margin greater than or equal to a threshold margin among the first candidate voltage and the second candidate voltage.

In some implementations, the voltage determiner may determine, as the final voltage, a candidate voltage including an OFF voltage having a smaller magnitude among the first OFF voltage and the second OFF voltage when each of a first stability margin by the first candidate voltage and a second stability margin by the second candidate voltage is greater than or equal to a threshold margin.

In some implementations, the voltage determiner may determine, as the final voltage, a candidate voltage that causes the plurality of SPADS to have a standby current lower than a threshold current, among the first candidate voltage and the second candidate voltage.

In accordance with another embodiment of the present disclosure, a method for operating an image sensing device may include: acquiring a first candidate voltage and a second candidate voltage, the first candidate voltage including a first anode voltage and a first cathode voltage for a single-photon avalanche diode (SPAD), and the second candidate voltage including a second anode voltage and a second cathode voltage for the SPAD; determining one of the first candidate voltage and the second candidate voltage as a final voltage based on at least one of a reliability margin of the SPAD or a stability margin of the SPAD; and applying the final voltage to the SPAD.

It is to be understood that both the foregoing general description and the following detailed description of the present disclosure are illustrative and explanatory and are intended to provide further explanation of the present disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an example of an image sensing device based on some embodiments of the present disclosure.

FIG. 2 is a block diagram illustrating an example of an image sensing device based on some embodiments of the present disclosure.

FIG. 3 is a circuit diagram illustrating an example of a single-photon avalanche diode (SPAD) pixel based on some embodiments of the present disclosure.

FIG. 4 is a conceptual diagram illustrating a stability margin based on some embodiments of the present disclosure.

FIG. 5 is a conceptual diagram illustrating a reliability margin and a stability margin based on some embodiments of the present disclosure.

FIG. 6 is a flowchart illustrating an example of a method for operating the image sensing device based on some embodiments of the present disclosure.

FIG. 7 is a flowchart illustrating an example of a method for operating the image sensing device based on some embodiments of the present disclosure.

FIG. 8 is a flowchart illustrating an example of a method for operating the image sensing device based on some embodiments of the present disclosure.

### DETAILED DESCRIPTION

The present disclosure provides implementations and examples of an image sensing device and a method for operating the same that may be used in configurations to substantially address one or more technical or engineering issues and to mitigate limitations or disadvantages encountered in some other image sensing devices. Some implementations of the present disclosure relate to an image sensing device that determines an optimal SPAD voltage by considering both a reliability margin and a stability margin. Some implementations of the present disclosure relate to an image sensing device having a stable standby current. Some implementations of the present disclosure relate to an image sensing device that determines an optimal SPAD voltage based on an excess voltage. In recognition of the issues above, the present disclosure may provide an image sensing device that determines an optimal SPAD voltage by considering both a reliability margin and a stability margin. The present disclosure may provide an image sensing device having a stable standby current. The present disclosure may provide an image sensing device that determines an optimal SPAD voltage based on an excess voltage.

Reference will now be made in detail to the embodiments of the present disclosure, examples of which are illustrated in the accompanying drawings. Wherever possible, the same reference numbers will be used throughout the drawings to refer to the same or like parts. While the present disclosure is susceptible to various modifications and alternative forms, specific embodiments thereof are shown by way of example in the drawings. However, the present disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein.

In the following description of embodiments of the present disclosure, a detailed description of known functions and configurations incorporated herein will be omitted when it may make the subject matter of the present disclosure rather unclear. In the drawings, parts that are not related to a description of the present disclosure are omitted to clearly explain the present disclosure and similar reference numbers will be used throughout this specification to refer to similar parts.

In the present disclosure, when a component is referred to as being “connected”, “coupled”, or “joined” to another component, it may include not only a direct connection relationship but also an indirect connection relationship in which another component is present therebetween. In addition, when a component “comprises”, “includes” or “has” another component, this means that the component does not exclude other components unless specifically stated above but may further include other components.

In the present disclosure, terms such as “first”, “second”, etc. are used only to distinguish one element from other elements and is not used to limit elements, and unless otherwise specified, it does not limit an order or importance, etc. of elements. Accordingly, within a scope of the present disclosure, a first element in an embodiment may be referred to as a second element in another embodiment and likewise, a second element in an embodiment may be referred to as a first element in another embodiment.

In the following description, components are discriminated from each other to clearly describe their characteristics, but this does not mean that they are necessarily physically separated. That is, a plurality of components may be integrated into one hardware or software module and one component may be divided into a plurality of hardware or software modules. Accordingly, integrated or divided embodiments are within the scope of the present disclosure even if not specifically stated.

In the following description, components described with reference to various embodiments are not all necessarily required and some components may be selectively used. Accordingly, embodiments composed of some of the components described in one embodiment are also within the scope of the present disclosure. Further, embodiments implemented by adding components to various embodiments are also within the scope of the present disclosure.

In the present disclosure expressions of positional relationships used in the present specification such as “top”, “upper”, “bottom”, “lower”, “left”, “right”, etc., are employed for the convenience of explanation, and when the drawings illustrated in the present specification are viewed in reverse, the positional relationships described in the specification may be interpreted in the opposite way.

In the present disclosure, each of phrases such as “A or B”, “at least one of A and B”, “at least one of A or B”, “A, B or C”, “at least one of A, B and C”, “and “at least one of A, B, or C” may include one or all possible combinations of the items listed together in the corresponding one of the phrases. In description of the present disclosure, the term “and/or” may include a combination of a plurality of items or one of a plurality of listed items. For example, “A or B” may include “only A”, “only B”, or “both A and B”.

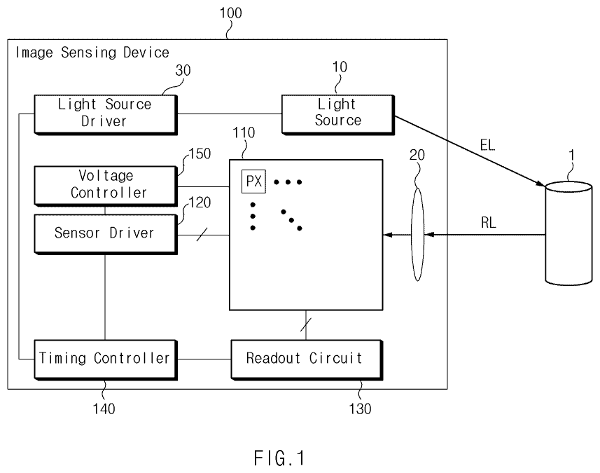

Hereinafter, embodiments of the present disclosure will be described in detail with reference to FIGS. 1 to 8.

FIG. 1 is a block diagram illustrating an example of an image sensing device 100 based on some embodiments of the present disclosure.

Referring to FIG. 1, the imaging device 100 may refer to a device, for example, a digital still camera for photographing still images or a digital video camera for photographing moving images. For example, the image sensing device 100 may be implemented as a Digital Single Lens Reflex (DSLR) camera, a mirrorless camera, or a smartphone, and others. The image sensing device 100 may include a device having both a lens and an image pickup element such that the device can capture (or photograph) a target object and can thus create an image of the target object. For example, the image sensing device 100 may be implemented as a Light Detection and Ranging (LIDAR) sensor.

In addition, the image sensing device 100 may be a complementary metal oxide semiconductor image sensor (CIS) for converting an incident light into an electrical signal. The image sensing device 100 may include a light source 10, a lens module 20, a light source driver 30, a pixel array 110, a sensor driver 120, a readout circuit 130, a timing controller 140, and a voltage controller 150.

The light source 10 may emit light to a target object 1 upon receiving a modulation light signal (MLS) from the light source driver 30. The light source 10 may be a laser diode (LD) or a light emitting diode (LED) for emitting light (e.g., near infrared (NIR) light, infrared (IR) light or visible light) having a specific wavelength band, or may be one of a Near Infrared Laser (NIR), a point light source, a monochromatic light source combined with a white lamp or a monochromator, and a combination of other laser sources. For example, the light source 10 may emit infrared light having a wavelength of 800 nm to 1000 nm. Meanwhile, light emitted from the light source 10 may be pulsed light having a predetermined period, amplitude, and pulse width. Although FIG. 1 shows only one light source 10 for convenience of description, the scope or spirit of the present disclosure is not limited thereto, and a plurality of light sources may also be arranged in the vicinity of the lens module 20.

The lens module 20 may collect light reflected from the target object 1, and may allow the collected light to be focused onto pixels (PXs) of the pixel array 110. For example, the lens module 20 may include a focusing lens having a surface formed of glass or plastic or another cylindrical optical element having a surface formed of glass or plastic. The lens module 20 may include a plurality of lenses that is arranged to be focused upon an optical axis.

The light source driver 30 may generate the modulation light signal (MLS) for driving the light source 10 under control of the timing controller 140. In particular, the light source driver 30 may control waveforms (e.g., a period, amplitude, pulse width, etc.) of emitted light (EL) output from the light source 10.

The pixel array 110 may include a plurality of pixels (PXs) consecutively arranged in a two-dimensional (2D) matrix structure (e.g., consecutively arranged in a column direction and/or a row direction). Each of the plurality of pixels (PXs) may generate a pixel signal by sensing incident light received through the lens module 20 under control of the sensor driver 120. The pixel array 110 may include a color filter array (CFA) in which color filters are arranged according to a predetermined pattern (e.g., a Bayer pattern, a quad-Bayer pattern, nona-Bayer pattern, an RGBW pattern, etc.) so that each color filter can sense light of a predetermined wavelength band. The pattern of the image data (IDATA) may be determined according to the type of the pattern of the CFA.

Each pixel (PX) may be an infrared pixel for generating a pixel signal by sensing incident light that includes reflected light (RL) generated when emitted light (EL) from the light source 10 is reflected from the target object 1. Although the present embodiment assumes that the reflected light (RL) is light that is reflected from the target object 1 and incident upon the pixel array 110 for convenience of description, the scope or spirit of the present disclosure is not limited thereto. In some implementations, the infrared pixel may be a depth pixel for calculating the distance to the target object 1. According to another embodiment, the infrared pixel may include a pixel for generating an infrared image by simply sensing infrared light incident from a scene without sensing reflected light. According to another embodiment, the pixels (PXs) may include a pixel for generating a color image by sensing visible light incident from a scene. According to still another embodiment, the pixel (PX) may include a single-photon avalanche diode (SPAD) pixel.

The sensor driver 120 may drive the pixels (PXs) of the pixel array 110 in response to a timing signal output from the timing controller 140. For example, the sensor driver 120 may generate a control signal capable of selecting and controlling pixels (PXs) included in at least one row line from among a plurality of row lines of the pixel array 110.

The readout circuit 130 may process pixel signals received from the pixel array 120 under control of the timing controller 140, and may thus generate and store image data (IDATA) for detecting the distance to the target object 1. The image data (IDATA) may be digital data obtained by performing analog-to-digital conversion (ADC) on an analog pixel signal. To this end, the readout circuit 130 may include a correlated double sampler (CDS) circuit for performing correlated double sampling (CDS) on the pixel signals generated from the pixel array 110. In addition, the readout circuit 130 may include an analog-to-digital converter (ADC) for converting output signals of the CDS circuit into digital signals. In addition, the readout circuit 130 may include a buffer circuit that temporarily stores pixel data generated from the analog-to-digital converter (ADC) and outputs the pixel data under control of the timing controller 140. In addition, two column lines for transmitting the pixel signal may be assigned to each column of the pixel array 110, and structures for processing the pixel signal generated from each column line may be configured to correspond to the respective column lines.

The timing controller 140 may generate a timing signal to control the light source driver 30, the sensor driver 120, the readout circuit 130, and the voltage controller 160. In some implementations, the timing controller 140 may generate a timing signal according to either a predetermined setting value and/or a request received from an image processing device. In some implementations, the timing controller 140 may include a logic control circuit, a phase lock loop (PLL) circuit, a timing control circuit, a communication interface circuit and others.

The voltage controller 150 may control the voltage applied to the pixel (PX). For example, the voltage controller 150 may determine an anode voltage and a cathode voltage to be applied to the SPADs included in the pixel (PX), and may apply the determined voltages to the SPADs. Specifically, the voltage controller 150 may obtain candidate voltages, may determine one of the candidate voltages as a final voltage based on a reliability margin and/or a stability margin of the SPADs, and may transmit the final voltage to the SPADs. Although the voltage controller 150 of FIG. 1 is illustrated separately from the sensor driver 120, the scope or spirit of the image sensing device 100 according to an embodiment of the present disclosure is not limited thereto, and the voltage controller 150 may be included in the sensor driver 120 as needed. More specific details of a method for determining the voltage to be applied to the SPADs are described herein below.

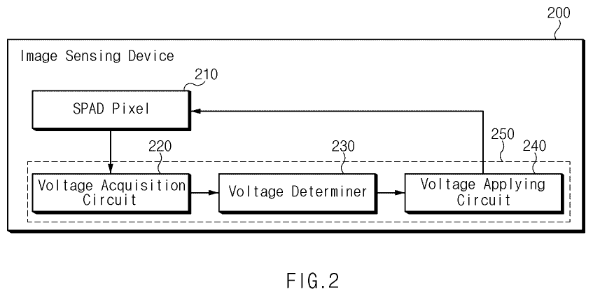

FIG. 2 is a block diagram illustrating an example of an image sensing device 200 based on some embodiments of the present disclosure.

Referring to FIG. 2, the image sensing device 200 may include a single-photon avalanche diode (SPAD) pixel 210 and a voltage controller 250. The voltage controller 250 may include a voltage acquisition circuit 220, a voltage determiner 230, and a voltage applying circuit 240. The voltage controller 250 may correspond to the voltage controller 150 of FIG. 1.

The SPAD pixel 210 may be a diode that detects a single photon. An anode voltage and a cathode voltage may be applied to the SPAD pixel 210. Reliability and stability of the SPAD pixel 210 may vary depending on the anode voltage and cathode voltage applied to the SPAD pixel 210. The reliability of the SPAD pixel 210 may be a measure indicating whether the SPAD pixel 210 that is turned off can prevent occurrence of unwanted breakdown. The stability of the SPAD pixel 210 may be a measure indicating whether the SPAD pixel 210 that is turned on may generate a signal having a stable rising edge (or a falling edge) (i.e., produce a consistent output when it detects a photon).

As the magnitude of an excess voltage determined according to the anode voltage and the cathode voltage decreases, it may be advantageous in terms of reliability of the SPAD pixel 210. As the magnitude of the excess voltage increases, it may be advantageous in terms of stability of the SPAD pixel 210. Here, the excess voltage may refer to a difference between the voltage applied to the SPAD pixel 210 when the SPAD pixel 210 is in the ON state (for example, a voltage difference between the anode voltage and the cathode voltage) and the breakdown voltage. Therefore, there is a trade-off between the reliability and stability of the SPAD pixel 210, and the image sensing device 200 according to the embodiment of the present disclosure may determine the optimal anode voltage and the optimal cathode voltage by considering both reliability and stability.

The voltage acquisition circuit 220 may acquire candidate voltages. The candidate voltages may refer to voltages including voltages to be applied to the anode and cathode of the SPAD pixel 210. Specifically, the candidate voltages may include an anode voltage and a cathode voltage. For example, a first candidate voltage may include a first anode voltage and a first cathode voltage, and a second candidate voltage may include a second anode voltage and a second cathode voltage.

The voltage acquisition circuit 220 may acquire candidate voltages by measuring voltages applied to the SPAD pixel 210. For example, assuming that there are a first SPAD and a second SPAD, the voltage acquisition circuit 220 may acquire a first candidate voltage by measuring voltages applied to the first SPAD, and may acquire a second candidate voltage by measuring voltages applied to the second SPAD. However, the method of acquiring the candidate voltages is not limited to the above-described method, and the image sensing device 200 according to the embodiment of the present disclosure may store a list of voltages that can be applied to the SPAD pixel 210 as a lookup table and may acquire the candidate voltages by referring to the lookup table.

The voltage determiner 230 may determine voltages to be applied to the SPAD pixel 210. For example, the voltage determiner 230 may determine one of the candidate voltages as the final voltage. Specifically, the voltage determiner 230 may determine one of the candidate voltages as the final voltage based on the reliability margin and/or stability margin of the SPAD pixel 210. More specific details on how the voltage determiner 230 determines the final voltage are described herein below with reference to the attached drawings.

The voltage applying circuit 240 may apply (or transmit) the final voltage determined by the voltage determiner 230 to the SPAD pixel 210.

The image sensing device 200 according to the embodiment of the present disclosure may be effectively operated by applying optimal voltages considering the reliability margin or the stability margin to the SPAD pixel 210.

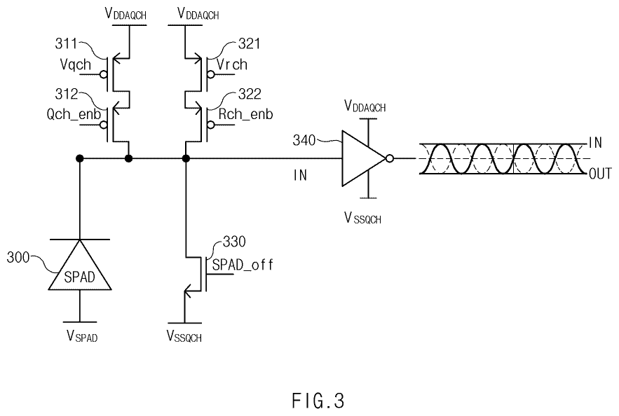

FIG. 3 is a circuit diagram illustrating an example of a single-photon avalanche diode (SPAD) pixel based on some embodiments of the present disclosure.

Referring to FIG. 3, a voltage (V_{SPAD}) may be applied to an anode of the SPAD 300. In addition, when the SPAD 300 is in the ON state in which the SPAD 300 operates in the Geiger mode, a voltage (V_{DDAQCH}) may be applied to a cathode of the SPAD 300 by quenching transistors (311, 312) or recharge transistors (321, 322). Each of the quenching transistors (311, 312) and the recharge transistors (321, 322) may be a PMOS transistor. The voltage (V_{DDAQCH}) may be applied to a source terminal of the quenching transistor 311, and a voltage (V_{qch}) may be applied to a gate terminal of the quenching transistor 311. In addition, a signal (Qch_enb) related to quenching enable may be input to a gate terminal of the quenching transistor 312. The voltage (V_{DDAQCH}) may be applied to a source terminal of the recharge transistor 321, and a voltage (V_{rch}) may be applied to a gate terminal of the recharge transistor 321. A signal (Rch_enb) related to recharge enable may be input to a gate terminal of the recharge transistor 322. In addition, when the SPAD 300 is in the OFF state, a voltage (V_{SSQCH}) may be applied to the cathode of the SPAD 300 by an SPAD-off transistor 330 to which a signal (SPAD_off) related to such SPAD off state is input. The SPAD-off transistor 330 may be an NMOS transistor. An output voltage of the SPAD 300 may be output through an inverter 340, and may have a waveform as shown in FIG. 3, but the scope of the waveform of the output voltage of the SPAD 300 is not limited thereto.

Hereinafter, the anode voltage of the SPAD 300 may be referred to as the voltage (V_{SPAD}), the cathode voltage of the SPAD 300 being in the ON state may be referred to as the voltage (V_{DDAQCH}), and the cathode of the SPAD 300 being in the OFF state may be assumed to be grounded.

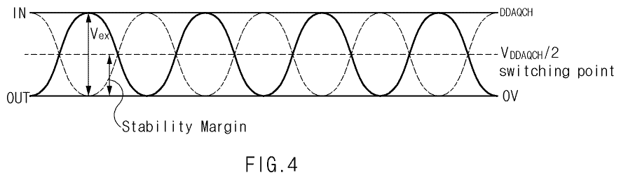

FIG. 4 is a conceptual diagram illustrating the stability margin based on some embodiments of the present disclosure. Specifically, FIG. 4 is a diagram illustrating that an input voltage and an output voltage of the inverter 340 of FIG. 3 change over time. Hereinafter, the concept of FIG. 4 will be described with reference to FIG. 3.

Referring to FIG. 4, the input voltage of the inverter 340 may decrease from the voltage (V_{DDAQCH}) by the magnitude of the excess voltage (Vₑₓ). The excess voltage (Vₑₓ) may be a value obtained by subtracting the breakdown voltage (V_{breakdown}) from the voltage (V′_{SPAD}=V_{SPAD}−V_{DDAQCH}) applied to the SPAD. In other words, the excess voltage (Vₑₓ) may be calculated as a voltage (V′_{SPAD}−V_{breakdown}). As the input voltage further decreases from the voltage (V_{DDAQCH}), the output voltage of the inverter 340 may further increase. A large increase in the output voltage may mean that a pulse signal can be stably generated, and may also mean that the stability of the SPAD is high. Therefore, the stability margin may be calculated as a value obtained by subtracting half of the magnitude of the voltage (V_{DDAQCH}) from the magnitude of the excess voltage (Vₑₓ) to indicate that the output voltage can increase significantly. In other words, the stability margin may be calculated by the equation denoted by “|Vₑₓ|−|V_{DDAQCH}|/2”. As the stability margin increases, the SPAD can operate more stably. Half of the magnitude of the voltage (V_{DDAQCH}) may be referred to as a switching point.

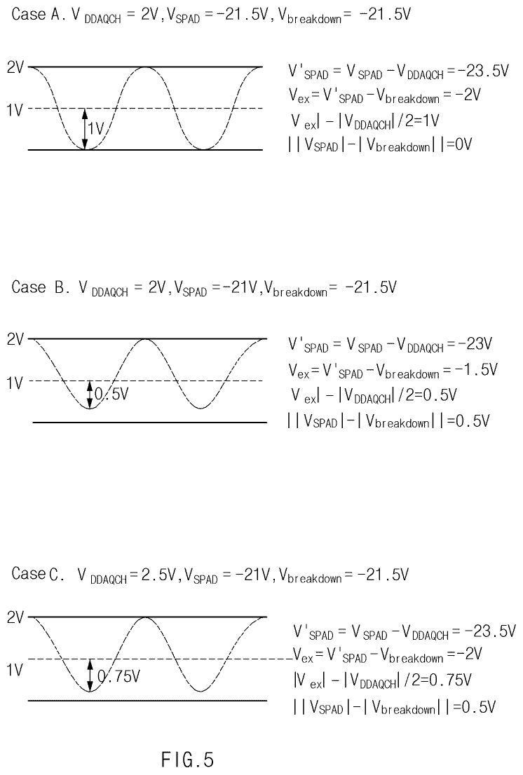

FIG. 5 is a conceptual diagram illustrating the reliability margin and the stability margin based on some embodiments of the present disclosure.

It is determined that the SPAD reliability increases as the possibility of occurrence of a current flowing into the turned-off SPAD decreases. Accordingly, as a difference in magnitude between the voltage applied to the turned-off SPAD and the breakdown voltage of the SPAD increases, the SPAD may have a higher reliability. Therefore, the reliability margin may be calculated as ∥V′_{SPAD}|−|V_{breakdown}∥, where V′_{SPAD} represents the voltage applied to the SPAD, and V_{breakdown} represents the breakdown voltage. As shown in FIG. 3, when the SPAD is in the OFF state, the cathode of the SPAD is grounded, so that the voltage (V′_{SPAD}) to be applied to the SPAD may be denoted by the anode voltage “V_{SPAD} (V′_{SPAD}=V_{SPAD}−0)”. Therefore, the reliability margin may be calculated as “∥V_{SPAD}|−|V_{breakdown}∥”.

Referring to FIG. 5, in Case (A), when the SPAD is in the ON state, the cathode voltage (V_{DDAQCH}) of the SPAD may be 2 volts (V), the anode voltage (V_{SPAD}) of the SPAD may be −21.5 V, and the breakdown voltage (V_{breakdown}) of the SPAD may be −21.5 V.

The reliability margin “∥V_{SPAD}|−|V_{breakdown}∥” of Case (A) may be denoted by “∥−21.5|−|−21.5∥=0”.

In Case (B), when the SPAD is in the ON state, the cathode voltage (V_{DDAQCH}) of the SPAD may be 2 volts (V), the anode voltage (V_{SPAD}) of the SPAD may be −21 V, and the breakdown voltage (V_{breakdown}) of the SPAD may be −21.5 V.

The reliability margin “∥V_{SPAD}|−|V_{breakdown}∥” of Case (B) may be denoted by “∥−21|−|−21.5∥=0.5”.

In Case (C), when the SPAD is in the ON state, the cathode voltage (V_{DDAQCH}) of the SPAD may be 2.5 V, the anode voltage (V_{SPAD}) of the SPAD may be −21 V, and the breakdown voltage (V_{breakdown}) of the SPAD may be −21.5 V.

The reliability margin “∥V_{SPAD}|−|V_{breakdown}∥” of Case (C) may be denoted by “∥−21|−|−21.5∥=0.5”.

Therefore, Case (B) and Case (C), each of which has a large reliability margin, may be more advantageous than Case (A) in terms of reliability.

Assuming that the respective cases (A, B, C) have the same reliability margin, as the magnitude of the excess voltage (Vₑₓ) decreases, the reliability becomes higher. Specifically, as the magnitude of the excess voltage (Vₑₓ) decreases, photon detection efficiency (PDE) may decrease.

In addition, the lower the PDE, the less the cumulative number of quenching and recharging operations of the SPAD, so that the SPAD may have a higher reliability.

As described above, the reliability margin of Case (B) and the reliability margin of Case (C) are equal to each other, but the magnitude of the excess voltage (Vₑₓ) of Case (B) is 1.5 and the magnitude of the excess voltage (Vₑₓ) of Case (C) is 2. As a result, Case (B) has the highest reliability, Case (C) has the intermediate reliability, and Case (A) has the lowest reliability (i.e., the reliability may be dependent on the reliability margin and the magnitude of the excess voltage (Vₑₓ)).

As described with reference to FIG. 4, the stability margin may be calculated as “|Vₑₓ|−|V_{DDAQCH}|/2. Therefore, the stability margin (|Vₑₓ|−|V_{DDAQCH}|/2) of Case (A) may be denoted by “|−2|−|2|/2=1”.

In addition, the stability margin (|Vₑₓ|−|V_{DDAQCH}|/2) of Case (B) may be denoted by “|−1.5|−|2|/2=0.5”.

The stability margin (|Vₑₓ|−|V_{DDAQCH}|/2) of Case (C) may be denoted by “|−2|−|2.5|/2=0.75”.

Therefore, Case (A) may have the highest stability margin, Case (B) may have the intermediate stability margin, and Case (C) may have the lowest stability margin.

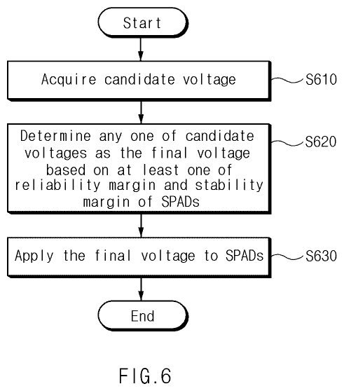

FIG. 6 is a flowchart illustrating an example of a method for operating the image sensing device based on some embodiments of the present disclosure.

Referring to FIG. 6, the method for operating the image sensing device may include obtaining candidate voltages in operation S610. For example, as in Case (A) of FIG. 5, the method for operating the image sensing device may include obtaining a first candidate voltage including a first anode voltage (V_{SPAD}) of −21.5 V and a first cathode voltage (V_{DDAQCH}) of 2 V. In addition, as in Case (B) of FIG. 5, the method for operating the image sensing device may include obtaining a second candidate voltage including a second anode voltage (V_{SPAD}) of −21 V and a second cathode voltage (V_{DDAQCH}) of 2 V. In addition, as in Case (C) of FIG. 5, the method for operating the image sensing device may include obtaining a third candidate voltage including a third anode voltage (V_{SPAD}) of −21 V and a third cathode voltage (V_{DDAQCH}) of 2.5 V.

In addition, the method for operating the image sensing device may include obtaining not only a first candidate voltage including a first ON voltage applied to each of the SPADs when the SPADs are turned on and a first OFF voltage applied to each of the SPADs when the SPADs are turned off, but also a second candidate voltage including a second ON voltage and a second OFF voltage. For example, as in Case (A) of FIG. 5, the method for operating the image sensing device may include obtaining a first candidate SPAD voltage including both a first ON voltage (V′_{SPAD}=V_{SPAD}−V_{DDAQCH}=−23.5 V) and a first OFF voltage (V_{SPAD}−0 V=V_{SPAD}=−21.5 V) when the first anode voltage (V_{SPAD}) of −21.5 V and the first cathode voltage (V_{DDAQCH}) are applied to the SPAD. In addition, as in Case (B) of FIG. 5, the method for operating the image sensing device may include obtaining a second candidate SPAD voltage including both a second ON voltage (V′_{SPAD}=V_{SPAD}−V_{DDAQCH}=−23 V) and a second OFF voltage (V_{SPAD}−0 V=V_{SPAD}=−21 V) when a second anode voltage (V_{SPAD}) of −21 V and a second cathode voltage (V_{DDAQCH}) of 2 V are applied to the SPAD. In addition, as in Case (C) of FIG. 5, the method for operating the image sensing device may include obtaining a first candidate SPAD voltage including both a third ON voltage (V′_{SPAD}=V_{SPAD}−V_{DDAQCH}=−23.5 V) and a third OFF voltage (V_{SPAD}−0 V=V_{SPAD}=−21 V) when a third anode voltage (V_{SPAD}) of −21 V and a third cathode voltage (V_{DDAQCH}) of 2.5 V are applied to the SPAD.

The operation of obtaining the candidate voltages can be performed by the voltage acquisition circuit.

The method for operating the image sensing device may include determining one of the candidate voltages as the final voltage based on the reliability margins and/or the stability margins of the SPADs in operation S620. For example, the method for operating the image sensing device may include determining an optimal candidate voltage as the final voltage by comparing the reliability margins and/or the stability margins of the candidate voltages with each other as described in FIG. 5.

Specifically, the method for operating the image sensing device may include determining a candidate voltage including an anode voltage (i.e., OFF voltage) having a larger (for example, greater) reliability margin among the first anode voltage (i.e., first OFF voltage) and the second anode voltage (i.e., second OFF voltage) as the final voltage. For example, the method for operating the image sensing device may include determining a candidate voltage including a voltage having a smaller magnitude among the first anode voltage (i.e., first OFF voltage) and the second anode voltage (i.e., second OFF voltage) as the final voltage.

In addition, the method for operating the image sensing device may include determining, as the final voltage, a candidate voltage having a lower excess voltage among the first candidate voltage and the second candidate voltage when the first anode voltage (i.e., first OFF voltage) and the second anode voltage (i.e., second OFF voltage) are equal to each other. In other words, the method for operating the image sensing device may include determining, as the final voltage, a candidate voltage corresponding to a smaller difference value among a first difference value (i.e., first ON voltage) between the first anode voltage and the first cathode voltage and a second difference value (i.e., second ON voltage) between the second anode voltage and the second cathode voltage when the first anode voltage (i.e., first OFF voltage) and the second anode voltage (i.e., second OFF voltage) are equal to each other.

The method for operating the image sensing device may include determining, as the final voltage, a candidate voltage corresponding to a higher value among a first value and a second value by considering the SPAD stability. In this case, the first value may be obtained by subtracting half of the magnitude of the first cathode voltage from the magnitude of the first excess voltage of the first candidate voltage, and a second value may be obtained by subtracting half of the magnitude of the second cathode voltage from the magnitude of the second excess voltage of the second candidate voltage.

In addition, the method for operating the image sensing device may include determining a candidate voltage having a stability margin greater than or equal to a threshold margin among the first candidate voltage and the second candidate voltage as the final voltage. The method for operating the image sensing device may include determining a candidate voltage including a voltage having a smaller magnitude among the first anode voltage (i.e., first OFF voltage) and the second anode voltage (i.e., second OFF voltage) as the final voltage when the first stability margin by the first candidate voltage and the second stability margin by the second candidate voltage are greater than or equal to the threshold margin.

In addition, the method for operating the image sensing device may include determining a final voltage among the candidate voltages based on the threshold current of the SPADs. The threshold current of the SPADs may be related to the stability of the SPADs, and may correspond to the stability margin of the SPADs. The method for operating the image sensing device may include determining, as the final voltage, a candidate voltage causing a SPAD standby current to be less than the threshold current among the first candidate voltage and the second candidate voltage.

In addition, the method for operating the image sensing device may include determining, as the final voltage, a candidate voltage including a voltage having a smaller magnitude among the first anode voltage (i.e., first OFF voltage) and the second anode voltage (i.e., second OFF voltage) when each of the first standby current by the first candidate voltage and the second standby current by the second candidate voltage is less than the threshold current.

The method for determining the final voltage among the candidate voltages may be performed by the voltage determiner.

More specific details and examples of the method for determining the optimal candidate voltage as the final voltage are described herein below with reference to the attached drawings.

The method for operating the image sensing device may include applying the final voltage to the SPADs in operation S630. The method for operating the image sensing device may secure higher reliability and higher stability for the SPADs by determining the optimal SPAD voltage as the final voltage and applying the determined final voltage to the SPADs in consideration of the SPAD reliability and the SPAD stability.

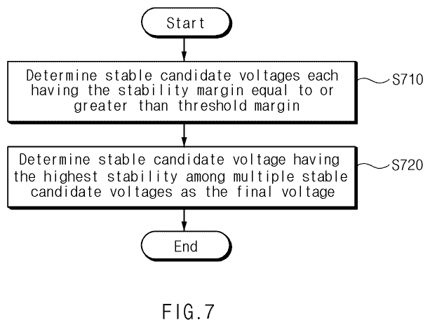

FIG. 7 is a flowchart illustrating an example of a method for operating the image sensing device based on some embodiments of the present disclosure.

Operations S710 and S720 of FIG. 7 may be obtained by specifying (for example, selecting, implementing in specific manners) the operation S620 of FIG. 6.

Referring to FIG. 7, the method for operating the image sensing device may include determining stable candidate voltages among candidate voltages each having a stability margin greater than or equal to a threshold margin (operation S710). For example, in a situation where the first candidate voltage (see Case A of FIG. 5) including both the first anode voltage (V_{SPAD}) of −21.5 V and the first cathode voltage (V_{DDAQCH}) of 2 V, the second candidate voltage (see Case B of FIG. 5) including both the second anode voltage (V_{SPAD}) of −21 V and the second cathode voltage (V_{DDAQCH}) of 2 V, and the third candidate voltage (see Case C of FIG. 5) including both the third anode voltage (V_{SPAD}) of −21 V and the third cathode voltage (V_{DDAQCH}) of 2.5 V are obtained, assuming that a threshold margin is set to 0.75 V, the second candidate voltage having a stability margin of 0.5 V may be excluded from target objects required to determine the final voltage, and the first candidate voltage having a stability margin of 1 V and the third candidate voltage having a stability margin of 0.75 V may be determined as stable candidate voltages which are the target objects required to determine the final voltage.

The method for operating the image sensing device may include determining stable candidate voltages among the candidate voltages, wherein each of the stable candidate voltages causes a standby current to be less than the threshold current. For example, in a situation where the first candidate voltage (see Case A of FIG. 5) including both the first anode voltage (V_{SPAD}) of −21.5 V and the first cathode voltage (V_{DDAQCH}) of 2 V, and the second candidate voltage (see Case B of FIG. 5) including both the second anode voltage (V_{SPAD}) of −21 V and the second cathode voltage (V_{DDAQCH}) of 2 V are obtained, assuming that a standby current of the first candidate voltage is 0.00001 mA, a standby current of the second candidate voltage is 0.00001 mA, and a threshold current is 0.001 mA, both the first candidate voltage and the second candidate voltage may be determined as stable candidate voltages which are target objects required to determine the final voltage.

In operation S720, the method for operating the image sensing device may include determining, as the final voltage, a stable candidate voltage having the highest reliability among the stable candidate voltages, each of which has a stability margin greater than or equal to the threshold margin. More specific details of the method for determining the final voltage among the stable candidate voltages are described herein below.

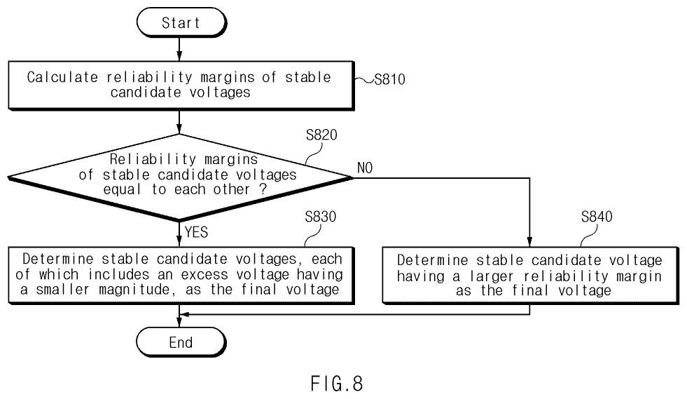

FIG. 8 is a flowchart illustrating an example of a method for operating the image sensing device based on some embodiments of the present disclosure.

Operations S810 to S840 of FIG. 8 may be obtained by specifying the operation S720 of FIG. 7.

Referring to FIG. 8, the method for operating the image sensing device may include calculating reliability margins of the stable candidate voltages in operation S810. For example, the reliability margin may be calculated through the equation “∥V_{SPAD}|−|V_{breakdown}∥”.

In operation S820, the method for operating the image sensing device may include determining whether reliability margins of the stable candidate voltages are equal to each other (or, for example, within a specified threshold of each other). For example, in a situation where the second candidate voltage (see Case B of FIG. 5) including both the second anode voltage (V_{SPAD}) of −21 V and the second cathode voltage (V_{DDAQCH}) of 2 V, and the third candidate voltage (see Case C of FIG. 5) including both the third anode voltage (V_{SPAD}) of −21 V and the third cathode voltage (V_{DDAQCH}) of 2.5 V are determined as stable candidate voltages, the reliability margin of the second candidate voltage may be 0.5 V and the reliability margin of the third candidate voltage may also be 0.5 V, which are equal to each other. In this case (S820, YES), the method for operating the image sensing device may proceed to operation S830, so that a stable candidate voltage having a lower excess voltage (Vₑₓ) can be determined as the final voltage. For example, since the magnitude of the excess voltage (Vₑₓ) of the second candidate voltage is 1.5 and the magnitude of the excess voltage (Vₑₓ) of the third candidate voltage is 2, the second candidate voltage can be determined as the final voltage.

In contrast, in a situation where the first candidate voltage (see Case A of FIG. 5) including both the first anode voltage (V_{SPAD}) of −21.5 V and the first cathode voltage (V_{DDAQCH}) of 2 V, and the second candidate voltage (see Case B of FIG. 5) including both the second anode voltage (V_{SPAD}) of −21 V and the second cathode voltage (V_{DDAQCH}) of 2 V are determined as stable candidate voltages, the reliability margin of the first candidate voltage may be zero volts (0 V) and the reliability margin of the second candidate voltage may be 0.5 V, which are different from each other. In this case (S820, NO), the method for operating the image sensing device may proceed to operation S840, so that a stable candidate voltage having a larger (for example, greater) reliability margin can be determined as the final voltage. For example, since the reliability margin of the first candidate voltage is zero volts (0 V) and the reliability margin of the second candidate voltage is 0.5 V, the second candidate voltage can be determined as the final voltage.

After, the final voltage is determined, the method for operating the image sensing device may include applying the final voltage to the SPADS.

As is apparent from the above description, the image sensing device according to the embodiments of the present disclosure may determine an optimal single-photon avalanche diode (SPAD) voltage by considering both a reliability margin and a stability margin.

The image sensing device according to the embodiments of the present disclosure can be implemented to have a stable standby current.

The image sensing device according to the embodiments of the present disclosure may determine an optimal SPAD voltage based on an excess voltage.

The embodiments of the present disclosure may provide a variety of effects capable of being directly or indirectly recognized through the present disclosure.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in the present disclosure.

What is claimed is:

1. An image sensing device comprising:
a plurality of single-photon avalanche diodes (SPADs);
a voltage acquisition circuit configured to acquire a first candidate voltage and a second candidate voltage, the first candidate voltage including a first anode voltage and a first cathode voltage for the plurality of SPADs, and the second candidate voltage including a second anode voltage and a second cathode voltage for the plurality of SPADs;
a voltage determiner configured to determine one of the first candidate voltage and the second candidate voltage as a final voltage based on at least one of a reliability margin of the plurality of SPADs or a stability margin of the plurality of SPADs; and
a voltage applying circuit configured to apply the final voltage to each of the plurality of SPADs.

2. The image sensing device according to claim 1, wherein the voltage determiner is configured to determine, as the final voltage, a candidate voltage including an anode voltage having a greater reliability margin among the first anode voltage and the second anode voltage.

3. The image sensing device according to claim 1, wherein the voltage determiner is configured to determine, as the final voltage, a candidate voltage including an anode voltage having a smaller magnitude among the first anode voltage and the second anode voltage.

4. The image sensing device according to claim 1, wherein the voltage determiner is configured to determine, as the final voltage, a candidate voltage having a lower excess voltage among the first candidate voltage and the second candidate voltage when the first anode voltage and the second anode voltage are equal to each other.

5. The image sensing device according to claim 1,
wherein the voltage determiner is configured to determine, as the final voltage, a candidate voltage corresponding to a smaller difference value between a first difference value and a second difference value when the first anode voltage and the second anode voltage are equal to each other, and
wherein the first difference value is a difference between the first anode voltage and the first cathode voltage, and the second difference value is a difference between the second anode voltage and the second cathode voltage.

6. The image sensing device according to claim 1,
wherein the voltage determiner is configured to determine, as the final voltage, a candidate voltage corresponding to a higher value among a first value and a second value, and
wherein the first value is obtained by subtracting half of a magnitude of the first cathode voltage from a magnitude of a first excess voltage of the first candidate voltage, and the second value is obtained by subtracting half of a magnitude of the second cathode voltage from a magnitude of a second excess voltage of the second candidate voltage.

7. The image sensing device according to claim 1, wherein the voltage determiner is configured to determine, as the final voltage, a candidate voltage having a stability margin greater than or equal to a threshold margin among the first candidate voltage and the second candidate voltage.

8. The image sensing device according to claim 1, wherein the voltage determiner is configured to determine, as the final voltage, a candidate voltage including a voltage having a smaller magnitude among the first anode voltage and the second anode voltage when each of a first stability margin by the first candidate voltage and a second stability margin by the second candidate voltage is greater than or equal to a threshold margin.

9. The image sensing device according to claim 1, wherein the voltage determiner is configured to determine, as the final voltage, a candidate voltage that causes the plurality of SPADs to have a standby current lower than a threshold current, among the first candidate voltage and the second candidate voltage.

10. The image sensing device according to claim 1, wherein the voltage determiner is configured to determine, as the final voltage, a candidate voltage including an anode voltage having a smaller magnitude among the first anode voltage and the second anode voltage when each of a first standby current by the first candidate voltage and a second standby current by the second candidate voltage is less than a threshold current.

11. The image sensing device according to claim 1,
wherein the plurality of SPADs includes a first SPAD and a second SPAD, and
wherein the voltage acquisition circuit is configured to:
acquire the first candidate voltage by measuring voltages applied to the first SPAD; and
acquire the second candidate voltage by measuring voltages applied to the second SPAD.

12. An image sensing device comprising:
a plurality of single-photon avalanche diodes (SPADs);
a voltage acquisition circuit configured to
acquire a first candidate voltage including a) a first ON voltage applied to each of the plurality of SPADs when the plurality of SPADs is in an ON state in which the plurality of SPADs operates in a Geiger mode and b) a first OFF voltage applied to each of the plurality of SPADs when the plurality of SPADs is in an OFF state in which one terminal of each of the plurality of SPADs is grounded, and
acquire a second candidate voltage including a second ON voltage and a second OFF voltage;
a voltage determiner configured to determine one of the first candidate voltage and the second candidate voltage as a final voltage based on at least one of a reliability margin of the plurality of SPADs or a stability margin of the plurality of SPADs; and
a voltage applying circuit configured to apply the final voltage to each of the plurality of SPADs.

13. The image sensing device according to claim 12, wherein the voltage determiner is configured to determine, as the final voltage, a candidate voltage including an OFF voltage having a greater reliability margin among the first OFF voltage and the second OFF voltage.

14. The image sensing device according to claim 12, wherein the voltage determiner is configured to determine, as the final voltage, a candidate voltage including an OFF voltage having a smaller magnitude among the first OFF voltage and the second OFF voltage.

15. The image sensing device according to claim 12, wherein the voltage determiner is configured to determine, as the final voltage, a candidate voltage including an excess voltage having a smaller magnitude among the first candidate voltage and the second candidate voltage when the first OFF voltage and the second OFF voltage are equal to each other.

16. The image sensing device according to claim 12, wherein the voltage determiner is configured to determine, as the final voltage, a candidate voltage having a lower ON voltage among the first ON voltage and the second ON voltage when the first OFF voltage and the second OFF voltage are equal to each other.

17. The image sensing device according to claim 12, wherein the voltage determiner is configured to determine, as the final voltage, a candidate voltage having a stability margin greater than or equal to a threshold margin among the first candidate voltage and the second candidate voltage.

18. The image sensing device according to claim 12, wherein the voltage determiner is configured to determine, as the final voltage, a candidate voltage including an OFF voltage having a smaller magnitude among the first OFF voltage and the second OFF voltage when each of a first stability margin by the first candidate voltage and a second stability margin by the second candidate voltage is greater than or equal to a threshold margin.

19. The image sensing device according to claim 12, wherein the voltage determiner is configured to determine, as the final voltage, a candidate voltage that causes the plurality of SPADs to have a standby current lower than a threshold current, among the first candidate voltage and the second candidate voltage.

20. A method for operating an image sensing device, the method comprising:
acquiring a first candidate voltage and a second candidate voltage, the first candidate voltage including a first anode voltage and a first cathode voltage for a single-photon avalanche diode (SPAD), and the second candidate voltage including a second anode voltage and a second cathode voltage for the SPAD;
determining one of the first candidate voltage and the second candidate voltage as a final voltage based on at least one of a reliability margin of the SPAD or a stability margin of the SPAD; and
applying the final voltage to the SPAD.
